(19) United States
(12) Patent Application Publication
(10) Pub. No.: US 2018/0046683 A1
(43) Pub. Date: Feb. 15, 2018

(54) SEARCH WORD LIST PROVIDING DEVICE AND METHOD USING SAME

(71) Applicant: NAVER CORPORATION, Seongnam-si (KR)

(72) Inventor: Byung Guk Lim, Seongnam-si (KR)

(73) Assignee: NAVER CORPORATION, Seongnam-si (KR)

(21) Appl. No.: 15/729,209

(22) Filed: Oct. 10, 2017

Related U.S. Application Data
(63) Continuation-in-part of application No. PCT/KR2016/004217, filed on Apr. 22, 2016.

(30) Foreign Application Priority Data
May 15, 2015 (KR) 10-2015-0068185

(51) Int. Cl. G06F 17/30

(52) U.S. Cl. CPC G06F 17/30554; G06F 17/3053

(57) ABSTRACT

A method of providing a search word list includes acquiring a tag set in a search word, applying an effect corresponding to the tag to the search word, and providing a search word list including the search word to which the effect has been applied.

### CROSS-REFERENCE TO RELATED APPLICATIONS

This is a continuation-in-part application of International Application No. PCT/KR2016/004217, filed Apr. 22, 2016, which claims benefit of Korean Patent Application No. 10-2015-0068185, filed May 15, 2015.

### BACKGROUND OF THE INVENTION

### Field of Invention

The present invention relates to a device for providing a search word list and a method of providing a search word list using the same, and more particularly, to a device for providing a search word list which enables a user to know what kind of content is related to a search word without selecting and checking search words one by one and a method of providing a search word list using the device.

### Description of Related Art

When a search word is input by a searcher, a search server which provides a search service provides search results to the searcher in response to the corresponding keyword.

When an issue arises in a specific period of time, an input frequency of a search word related to the issue suddenly increases. Therefore, by generating and providing a search word list including such search words, the search server may suggest search words related to issues which have arisen in the corresponding period of time to a user.

The above-described background art is technology information that has been held by the inventor to derive the present invention or has been acquired during the procedure of deriving the present invention. The background art is not necessarily considered as a known technology open to the public prior to the filing of this application.

For example, Korean Patent Publication No. 10-2007-0117526 (published on Dec. 12, 2007) “Real-time rush keyword extraction method and real-time rush keyword extraction system” discloses a technology for extracting real-time hot keywords.

### BRIEF SUMMARY OF THE INVENTION

Embodiments of the present invention provide a device for providing a search word list including search words in which tags have been set and a method of providing a search word list using the device.

Embodiments of the present invention also provide a device for providing a search word list which enables a user to easily know what kinds of content are related to search words without acquiring search results of the search words one by one by applying effects corresponding to tags set in the search words to the search words and providing a search word list including the search words to which the effects have been applied, and a method of providing a search word list using the device.

An embodiment of the present invention discloses a device for providing a search word list, the device including: a tag acquisition unit configured to acquire a tag set in a search word; an effect application unit configured to apply an effect corresponding to the tag to the search word; and a search word list providing unit configured to provide a search word list including the search word to which the effect has been applied.

Another embodiment of the present invention discloses a method of providing a search word list, the method including: acquiring, by a tag acquisition unit, a tag set in a search word; applying, by an effect application unit, an effect corresponding to the tag to the search word; and providing, by a search word list providing unit, a search word list including the search word to which the effect has been applied.

Still another embodiment of the present invention discloses a computer program stored in a medium to cause a computer to execute the method.

Yet another embodiment of the present invention discloses a distribution server for distributing a program for causing a computer to execute the method.

Aspects, features, and advantages other than those described above will be obvious from the claims and detailed descriptions of the present invention.

A device for providing a search word list and a method of providing a search word list using the device according to embodiments of the present invention make it possible to provide a search word list including search words in which tags have been set.

Also, a device for providing a search word list and a method of providing a search word list using the device according to embodiments of the present invention enable a user to easily know what kinds of content are related to search words without acquiring search results of the search words one by one by applying effects corresponding to tags set in the search words to the search words and providing a search word list including the search words to which the effects have been applied.

### BRIEF DESCRIPTION OF THE DRAWINGS

FIG. 1 is a diagram showing a configuration of a system for providing a search word list according to an embodiment of the present invention.

FIG. 2 is a block diagram showing an example of an internal configuration of a device for providing a search word list shown in FIG. 1.

FIG. 3 is an operational flowchart showing a method of providing a search word list according to an embodiment of the present invention.

FIG. 4 is an example of a screen, in which a search word list is provided, of a user terminal shown in FIG. 1.

FIG. 5 is another example of a screen, in which a search word list is provided, of a user terminal shown in FIG. 1.

FIG. 6 is another example of a screen, in which a search word list is provided, of a user terminal shown in FIG. 1.

FIG. 7 is another example of a screen, in which a search word list is provided, of a user terminal shown in FIG. 1.

FIG. 8 is another example of a screen, in which a search word list is provided, of a user terminal shown in FIG. 1.

FIGS. 9A and 9B are examples of screens in which a search word list and a search result are provided, of a user terminal shown in FIG. 1.

### DETAILED DESCRIPTION OF THE INVENTION

The present invention may be modified in various ways and may have multiple embodiments, and specific embodiments are illustrated in the drawings and described in detail. Effects and features of the present invention and methods of achieving the same may be apparent with reference to the embodiments described in detail below together with the drawings. However, the present invention may be embodied in various forms and is not limited to the embodiments set forth herein. In the following embodiments, terms, such as “first,” “second,” and the like, do not have limited meanings and are used to distinguish one element from another element. A singular expression includes a plural expression unless the context clearly indicates otherwise. Terms, such as “include,” “have,” and the like, denote the presence of a feature or an element stated herein and do not preclude the probability of addition of one or more other features or elements. Also, in the drawings, sizes of elements may be exaggerated or contracted for convenience of description. For example, a size and a thickness of each element shown in the drawings are arbitrarily shown for convenience of description, and the present invention is not necessarily limited thereto.

Hereinafter, the embodiments of the present invention will be described in detail with reference to the accompanying drawings. When the embodiments of the present invention are described with reference to the drawings, identical elements or corresponding elements will be designated by the same reference numeral, and a duplicate description thereof will be omitted.

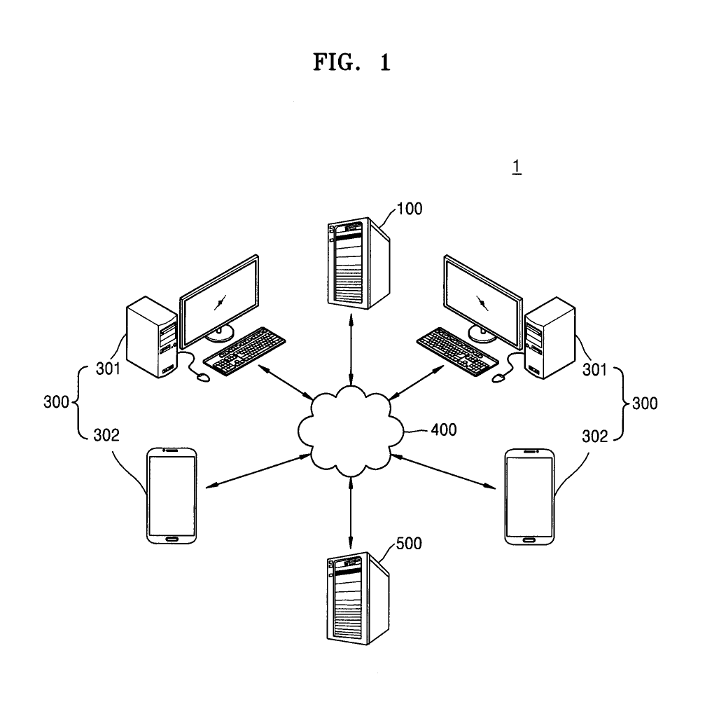

FIG. 1 is a diagram showing a configuration of a system 1 for providing a search word list according to an embodiment of the present invention.

Referring to FIG. 1, the system 1 for providing a search word list according to an embodiment of the present invention includes a device 100 for providing a search word list and user terminals 300. Also, the system 1 for providing a search word list includes a communication network 400 which connects the plurality of user terminals 300 and the device 100 for providing a search word list to each other.

The device 100 for providing a search word list according to an embodiment of the present invention provides a search word list to a user through a terminal application installed on a user terminal 300. More specifically, the device 100 for providing a search word list applies an effect corresponding to a tag to a search word in which the tag has been set and provides a search word list including the search word to the user through the terminal application of the user terminal 300.

The terminal application may be a terminal application embedded in the user terminal 300, a terminal application which is downloaded from an application distribution server and installed on the user terminal 300, or a web application which is provided through a web browser embedded or installed on the user terminal 300.

Here, the distribution server may include at least one control unit for distributing the terminal application. As a central processing unit (CPU), the control unit may provide various functions, such as management of uploading and downloading of the terminal application, management of a version of the terminal application, and the like. According to an embodiment, the distribution server may be included in the device 100. According to another embodiment, the distribution server may be separate from the device 100 and, therefore, it may not be included in the device 100. For example, a distribution server 500 may provide a digital platform of an online store or market for sharing computer program such as a terminal application. The digital platform may be implemented through a website and/or an application.

Here, the control unit may include any type of device capable of processing data, such as a processor. The “processor” may denote, for example, a data processing device which is embedded in hardware and has a physically structured circuit for executing codes included in a program or functions expressed as commands. Examples of the data processing device embedded in hardware may include a microprocessor, a CPU, a processor core, a multiprocessor, an application-specific integrated circuit (ASIC), a field programmable gate array (FPGA), and the like, but the scope of the present invention is not limited thereto.

Here, the device 100 for providing a search word list according to the present invention may provide advertisements and various other services for improving convenience of a user in addition to search words and a search result. In other words, the device 100 for providing a search word list according to the present invention may be a server which provides various services, such as an advertisement service, a search service, an email service, a blog service, a social network service, a news service, and a shopping information providing service.

The plurality of user terminals 300 denotes communication terminals capable of using the terminal application in a wired or wireless communication environment. Here, a user terminal 300 may be a personal computer 301 of a user or a portable terminal 302 of a user. Although portable terminals are shown as smart phones in FIG. 1, the spirit of the present invention is not limited thereto, and any terminal on which the terminal application is installed can be used without restriction as described above.

More specifically, the user terminals 300 may include a computer (e.g., a desktop computer, a laptop computer, a tablet computer, etc.), a media computing platform (e.g., a cable set-top box, a satellite set-top box, and a digital video recorder), a handheld computing device (e.g., a personal digital assistant (PDA), an email client, etc.), any type of cellular phone, or any type of computing or communication platform, but the present invention is not limited thereto.

The communication network 400 serves to connect the plurality of user terminals 300 to the device 100 for providing a search word list. In other words, the communication network 400 denotes a communication network which provides an access path so that the plurality of user terminals 300 may access the device 100 for providing a search word list and then transmit and receive data. Examples of the communication network 400 may encompass wired networks, such as local area networks (LANs), wide area networks (WANs), metropolitan area networks (MANs), integrated service digital networks (ISDNs), etc., and wireless networks, such as wireless LANs, code-division multiple access (CDMA) networks, Bluetooth networks, satellite communication networks, etc., but the scope of the present invention is not limited thereto.

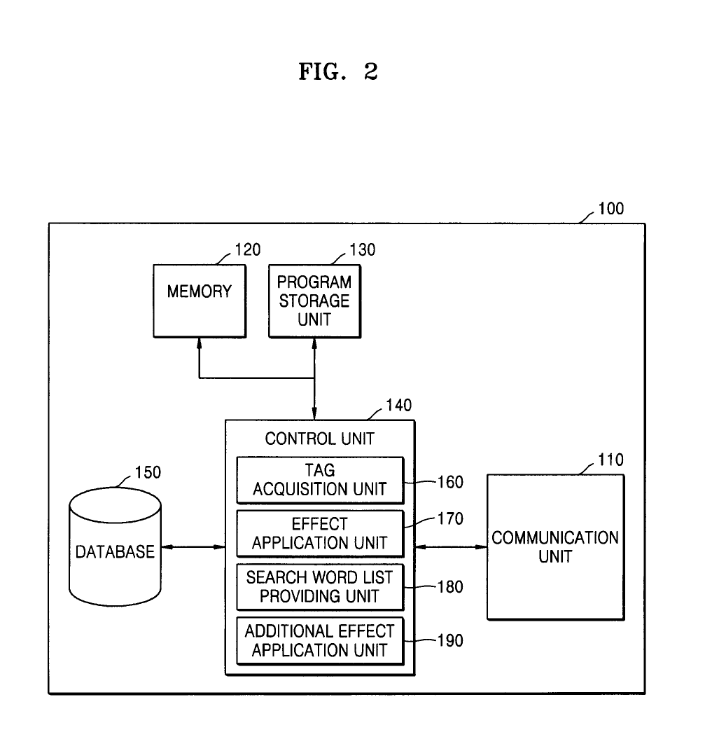

FIG. 2 is a block diagram showing an example of an internal configuration of the device 100 for providing a search word list shown in FIG. 1.

Referring to FIG. 2, the device 100 for providing a search word list includes a communication unit 110, a memory 120, a program storage unit 130, a control unit 140, a database 150, a tag acquisition unit 160, an effect application unit 170, a search word list providing unit 180, and an additional effect application unit 190.

The communication unit 110 provides a communication interface required to provide signals exchanged between the device 100 for providing a search word list and the user terminals 300 in the form of packet data by operating in conjunction with the communication network 400. Further, the communication unit 110 may serve to transmit search words or search results corresponding to search words to the user terminals 300 or receive input signals for search words or objects corresponding to search words from the user terminals 300.

Here, the communication unit 110 may be a device including hardware and software required to exchange signals, such as control signals or data signals, with another network device through a wired or wireless connection.

The memory 120 serves to temporarily or permanently store data processed by the control unit 140. Here, the memory 120 may include magnetic storage media or flash storage media, but the scope of the present invention is not limited thereto.

The program storage unit 130 stores control software for performing an operation of acquiring a tag set in a search word, an operation of acquiring an effect corresponding to the tag, an operation of applying the effect corresponding to the tag to the search word, an operation of generating a search word list including the search word to which the effect has been applied, an operation of providing the search word list, and the like.

As a CPU, the control unit 140 controls the entire process of acquiring a search word in which a tag has been set, applying an effect to the search word, and transmitting the search word to which the effect has been applied to a user terminal 300. In other words, the control unit 140 provides various functions of running the control software installed on the program storage unit 130, acquiring the tag set in the search word by controlling the tag acquisition unit 160, the effect application unit 170, the search word list providing unit 180, and additional effect application unit 190, applying the effect corresponding to the tag to the search word, transmitting the search word to which the effect has been applied to the user terminal 300, and the like.

Here, the control unit 140 may include any type of device capable of processing data, such as a processor. The “processor” may denote, for example, a data processing device which is embedded in hardware and has a physically structured circuit for executing codes included in a program or functions expressed as commands. Examples of the data processing device embedded in hardware may include a microprocessor, a CPU, a processor core, a multiprocessor, an ASIC, a FPGA, and the like, but the scope of the present invention is not limited thereto.

The database 150 stores information on search words, information on tags set in the search words, information on effects corresponding to the tags, and the like.

In selective embodiments, the database 150 may further store information on a “real-time hot search word” that is a search word whose input frequency suddenly increases in real time.

The tag acquisition unit 160 acquires a tag set in a search word. For example, when “GilX Hong” is a search word related to a death, a word which tells content or a state of the search word “GilX Hong,” such as “condolence,” may be set as a tag, and the tag acquisition unit 160 may acquire the tag “condolence.”

Tags may be set in advance to indicate content of search results according to search words. In each search word, no tag or one or more tags may be set. In selective embodiments, tags may be manually set by the manager of the device or/and the manager of the search engine service.

In selective embodiments, tags may be automatically set according to users' input histories of search words. For example, the device 100 may set a user category's name as a tag to a search word whose input frequency is suddenly increased by the certain user category. For example, the device 100 may automatically set the tag “adolescent” to the search word whose input frequency is suddenly increased by the user who has classified as a “adolescent” category. The user may be categorized according to the user information.

The effect application unit 170 applies an effect corresponding to a tag to a search word. When no tag is set in a specific search word, the effect application unit 170 may not apply any effect to the specific search word. When a plurality of tags are set in a specific search word, the effect application unit 170 may apply an effect corresponding to any one tag, mix effects separately corresponding to the plurality of tags and apply the mixed effects, or apply an effect corresponding to a combination of the tags.

The effect application unit 170 may apply a visual effect corresponding to a tag to an object corresponding to a search word. For example, the effect application unit 170 may apply a visual effect to objects, such as a search word string, a ranking symbol, ranking fluctuation information, and the like corresponding to a specific search word.

In selective embodiments, the effect application unit 170 may apply a color corresponding to a tag to a ranking symbol corresponding to a search word. For example, when the tag “condolence” is set in “GilX Hong” which is a search word ranking third in a search word list, the effect application unit 170 may apply black corresponding to the tag “condolence” to a third ranking symbol which is a ranking symbol corresponding to “GilX Hong.”

In selective embodiments, the effect application unit 170 may apply a font corresponding to a tag to a string of a search word. For example, when the tag “condolence” is set in “GilX Hong” which is a search word ranking third in a search word list, the effect application unit 170 may apply red corresponding to the tag “condolence” to the string “GilX Hong.” Font information corresponding to a tag is not limited to color information and may include a font, a letter size, whether there is an underline, and the like. For example, the effect application unit 170 may apply black and the font “bold” corresponding to the tag “condolence” to the string “GilX Hong.”

In selective embodiments, the effect application unit 170 may add an object corresponding to a tag according to a search word. For example, the effect application unit 170 may add an object, such as an infographic, an emoticon, etc., corresponding to a tag according to a search word. More specifically, when the tag “condolence” is set in “GilX Hong” which is a search word ranking third in a search word list, the effect application unit 170 may add a condolence ribbon, such as “ [symbol] [symbol] ” to the right of the string “GilX Hong” as an infographic corresponding to the tag “condolence.”

An infographic is a graphic indicating specific information, and in the present invention, an infographic may denote a symbol or an image denoting content of a search word. An emoticon is an icon indicating an emotion, and in the present invention, an emoticon may denote a symbol or an image denoting an emotion of a person who is a target of a search word or a reaction of a searcher. The effects corresponding to the tags may be predetermined and stored in the memory 120 of the device 100. The effect application unit 170 finds an effect corresponding to the tag of the search word from the memory, and determines that the found effect is to be applied to the search word. For example, the effect application unit 170 may find an effect, such as adding a condolence ribbon, corresponding to the tag “condolence” of the search word, from the memory, and determines that the found effect is to be applied to the search word.

The search word list providing unit 180 provides a search word list including a search word to which an effect has been applied. For example, the search word list providing unit 180 may provide a search word list including general search words to which no effect has been applied and a search word to which an effect has been applied.

In selective embodiments, the search word list providing unit 180 may provide a search word list including search words in which the same tag as a tag set in a specific search word has been set on the basis of an input signal for the search word. For example, when a selection signal for a ranking symbol or an infographic corresponding to a specific search word is input, the search word list providing unit 180 may provide a search word list including search words in which the same tag as a tag set in the search word is set. More specifically, when the tag “condolence” is set in “GilX Hong” which is a search word ranking third in a search word list and a selection signal for a third ranking symbol is input, the search word list providing unit 180 may provide a search word list including search words in which the tag “condolence” has been set.

The additional effect application unit 190 applies an additional effect to a search word on the basis of an input signal for the search word. The additional effect application unit 190 may apply a visual effect corresponding to a tag to a search result corresponding to the search word. For example, when a selection signal for a specific search word is input, the additional effect application unit 190 may apply a theme of a color corresponding to a tag to a search result corresponding to the search word. More specifically, when the tag “in love” is set in “GyuX Lee” which is a search word ranking tenth in a search word list and a selection signal for “GyuX Lee” is input, the additional effect application unit—190 may apply a pink theme corresponding to the tag “in love” to a search result corresponding to “GyuX Lee.” For example, a pink text box including a sentence, such as “A search word related to ‘love affairs’ has been selected.”, may be displayed in a search result.

In selective embodiments, the additional effect application unit 190 may add an object corresponding to a tag according to a search word. For example, when a signal for placing a pointer on a specific search word is input, the additional effect application unit 190 may insert an information message corresponding to a tag in a position adjacent to the search word. More specifically, when the tag “in love” is set in “GyuX Lee” which is a search word ranking tenth in a search word list and a signal for placing a pointer on “GyuX Lee” is input, the additional effect application unit 190 may provide an information message, such as “This is a real-time hot search word related to ‘love affairs.”’ corresponding to the tag “in love” to the right of the string “GyuX Lee.”

Here, the signal for placing a pointer may be a signal for moving a mouse pointer to a specific position by an input tool, such as a mouse or the like, in the case of the personal computer 301, and may be a signal distinguished from a selection signal, such as a signal generated by touching a specific position for a preset time or more to focus on the specific position, in the case of the portable terminal 302, but the signal for placing a pointer is not limited to these examples.

As described above, the device 100 for providing a search word list according to an embodiment of the present invention enables a user to easily know what kinds of content are related to search words without acquiring search results of the search words one by one by applying effects corresponding to tags set in the search words to the search words and providing a search word list including the search words to which the effects have been applied.

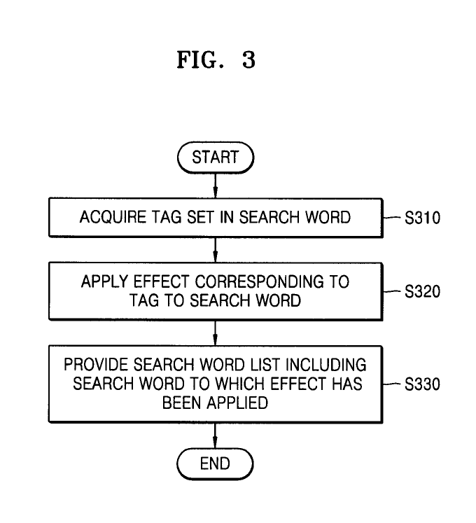

FIG. 3 is an operational flowchart showing a method of providing a search word list according to an embodiment of the present invention.

Referring to FIG. 3, a method of providing a search word list according to an embodiment of the present invention includes a step of acquiring a search word by the tag acquisition unit 160 (S310), a step of applying an effect to the search word by the effect application unit 170 (S320), and a step of providing a search word list including the search word to which the effect has been applied by the search word list providing unit 180 (S330).

First, the tag acquisition unit 160 acquires a tag set in a search word (S310). In selective embodiments, tags may be manually set by the manager of the device or/and the manager of the search engine service. In selective embodiments, tags may be automatically set according to users' input histories of search words.

Next, the effect application unit 170 applies an effect corresponding to the tag to the search word (S320). In step S320, the effect application unit 170 may apply a visual effect corresponding to the tag to an object corresponding to the search word or add an object corresponding to the tag according to the search word.

Next, the search word list providing unit 180 provides a search word list including the search word to which the effect has been applied (S330). In step S330, the search word list providing unit 180 may provide a search word list including search words in which the same tag as a tag set in a specific search word has been set on the basis of an input signal for the search word.

Although not shown in FIG. 3, the method of providing a search word list according to an embodiment of the present invention may further include a step of applying an additional effect to the search word on the basis of an input signal for the search word by the additional effect application unit 190.

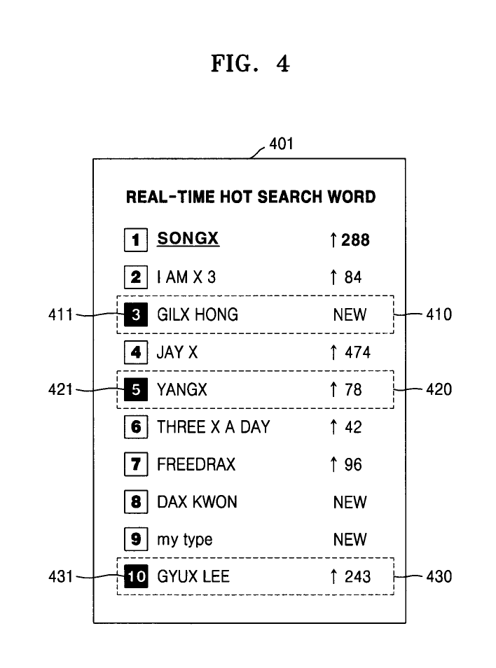

FIG. 4 is an example of a screen, in which a search word list is provided, of a user terminal 300 shown in FIG. 1.

Referring to FIG. 4, it is possible to see that the device 100 for providing a search word list shown in FIG. 1 provides a search word list 401 including search words to the user terminal 300. The search word list 401 may include search words sorted by ranking. Each search word may include a ranking symbol, a search word string, and ranking fluctuation information.

The search words may be classified as general search words in which no tag has been set and search words 410, 420, and 430 in which tags have been set. For example, it is possible to see that the tags “condolence,” “musician,” and “in love” are set in “GilX Hong” 410 which is a third-ranking search word, “YangX” 420 which is a fifth-ranking search word, and “GyuX Lee” 430 which is a tenth-ranking search word, respectively.

The device 100 for providing a search word list may apply colors corresponding to the tags to ranking symbols 411, 421, and 431 of the search words 410, 420, and 430 in which the tags have been set. For example, colors corresponding to the tags “condolence,” “musician,” and “in love” may be black, green, and pink, respectively. In this case, the device 100 for providing a search word list may apply black, green, and pink to the ranking symbols 411, 421, and 431, respectively. In this case, a user may know what kinds of content are related to the search words without acquiring search results of the search words one by one by recognizing the effects applied to the search words.

In this way, a device for providing a search word list according to an embodiment of the present invention applies effects to search words in which tags have been set, thereby enabling a user to easily know what kinds of content are related to search words without acquiring search results of the search words one by one.

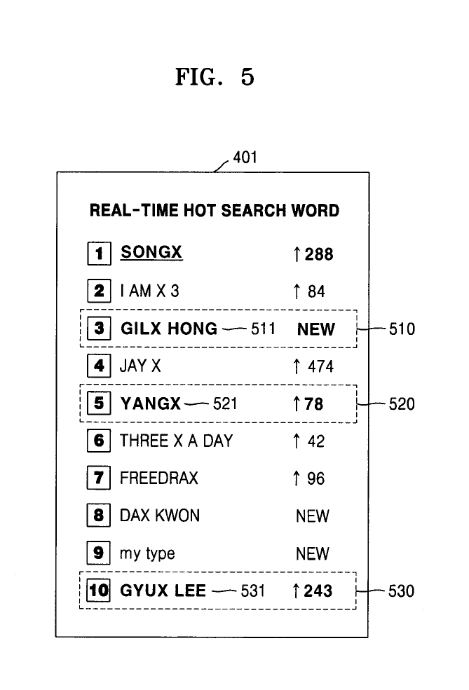

FIG. 5 is another example of a screen, in which a search word list is provided, of a user terminal 300 shown in FIG. 1.

Referring to FIG. 5, it is possible to see that the device 100 for providing a search word list shown in FIG. 1 provides the search word list 401 including search words to the user terminal 300.

The search words may be classified as general search words in which no tag has been set and search words 510, 520, and 530 in which tags have been set. For example, it is possible to see that the tags “condolence,” “musician,” and “in love” are set in GilX Hong” 510 which is a third-ranking search word, “YangX” 520 which is a fifth-ranking search word, and “GyuX Lee” 530 which is a tenth-ranking search word, respectively.

The device 100 for providing a search word list may apply colors corresponding to the tags to strings 511, 521, and 531 of the search words 510, 520, and 530 in which the tags have been set. For example, colors corresponding to the tags “condolence,” “musician,” and “in love” may be black, green, and pink, respectively. In this case, the device 100 for providing a search word list may apply black, green, and pink to the strings 511, 521, and 531, respectively. Also, the device 100 for providing a search word list may apply fonts corresponding to the tags to the strings 511, 521, and 531 of the search words 510, 520, and 530 in which the tags have been set. For example, the device 100 for providing a search word list may apply black and the font “bold” corresponding to the tag “condolence” to the string “GilX Hong.” In this case, a user may know what kinds of content are related to the search words without acquiring search results of the search words one by one by recognizing the effects applied to the search words.

In this way, a device for providing a search word list according to an embodiment of the present invention applies effects to search words in which tags have been set, thereby enabling a user to easily know what kinds of content are related to search words without acquiring search results of the search words one by one.

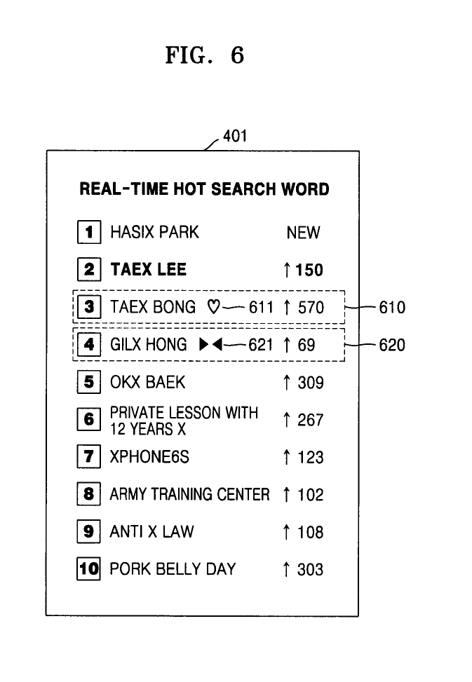

FIG. 6 is another example of a screen, in which a search word list is provided, of a user terminal 300 shown in FIG. 1.

Referring to FIG. 6, it is possible to see that the device 100 for providing a search word list shown in FIG. 1 provides the search word list 401 including search words to the user terminal 300.

The search words may be classified as general search words in which no tag has been set and search words 610 and 620 in which tags have been set. For example, it is possible to see that the tags “in love” and “condolence” are set in “TaeX Bong” 610 which is a third-ranking search word and “GilX Hong” 620 which is a fourth-ranking search word, respectively.

The device 100 for providing a search word list may add objects corresponding to the tags to the search words 610 and 620 in which the tags have been set. For example, objects corresponding to the tags “in love” and “condolence” may be symbols, such as “♡” 611 and “ [symbol] [symbol] ” 612. In this case, the device 100 for providing a search word list may add the symbols “♡” 611 and “ [symbol] [symbol] ” 612 to the right of strings of the search words 610 and 620, respectively. In this case, a user may know what kinds of content are related to the search words without acquiring search results of the search words one by one by recognizing the effects applied to the search words.

In this way, a device for providing a search word list according to an embodiment of the present invention applies effects to search words in which tags have been set, thereby enabling a user to easily know what kinds of content are related to search words without acquiring search results of the search words one by one.

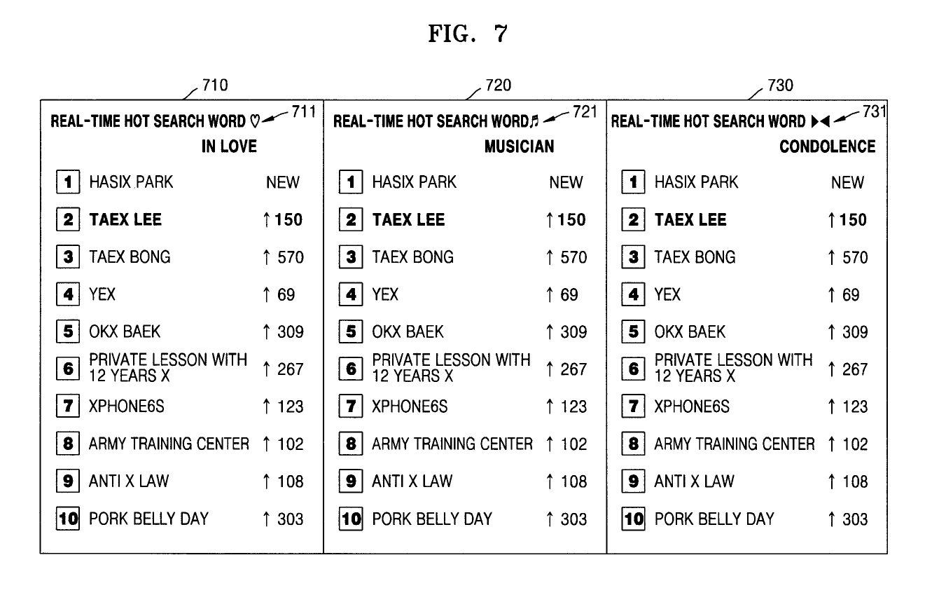

FIG. 7 is another example of a screen, in which a search word list is provided, of a user terminal 300 shown in FIG. 1.

Referring to FIG. 7, it is possible to see that the device 100 for providing a search word list shown in FIG. 1 provides search word lists 710, 720, and 730 each including only search words in which a specific tag has been set to the user terminal 300.

The search word lists 710, 720, and 730 may include only search words in which tags in “love” 711, “musician” 721, and “condolence” 731 have been set, respectively.

The device 100 for providing a search word list may display any one or more of the search word lists 710, 720, and 730 together on one screen as shown in FIG. 7.

In selective embodiments, when a selection signal for a specific tag is input, the search word list providing unit 180 may provide a search word list including only search words in which the tag has been set. For example, when a selection signal for the ranking symbol 411 of “GilX Hong” 410 in the search word list 401 shown in FIG. 4 is input, the device 100 for providing a search word list may determine that a selection signal for the tag “condolence” 731 set in “GilX Hong” 410 has been input, and may provide the search word list 730 including only search words in which the tag “condolence” 731 has been set.

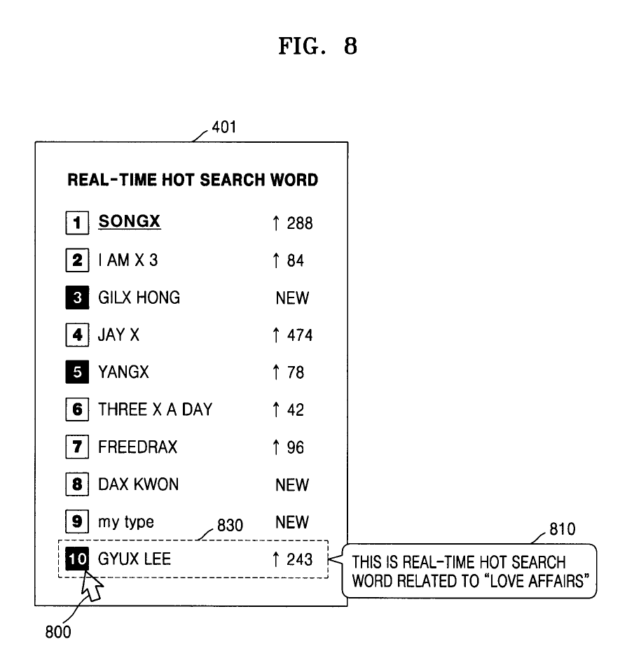

FIG. 8 is another example of a screen, in which a search word list is provided, of a user terminal shown in FIG. 1.

Referring to FIG. 8, it is possible to see that the device 100 for providing a search word list shown in FIG. 1 provides an information message 810 about a search word 830.

When a signal for placing a pointer 800 on the search word 830 is input, the device 100 for providing a search word list may provide the information message 810 corresponding to a tag set in the search word 830. For example, when a signal for placing the pointer 800 on “GyuX Lee” 830 is input, the device 100 for providing a search word list may provide the information message 810 corresponding to the tag “in love” set in the search word 830, such as “This is a real-time hot search word related to ‘love affairs.’” The device 100 may provide the information message 810 by inserting a term ‘love affairs’ which corresponds to the tag ‘in love’ of the search word 830 to a preset message format, such as “This is a real-time hot search word related to ‘[term]”’, so that the message “This is a real-time hot search word related to ‘love affairs.’” May be provided.

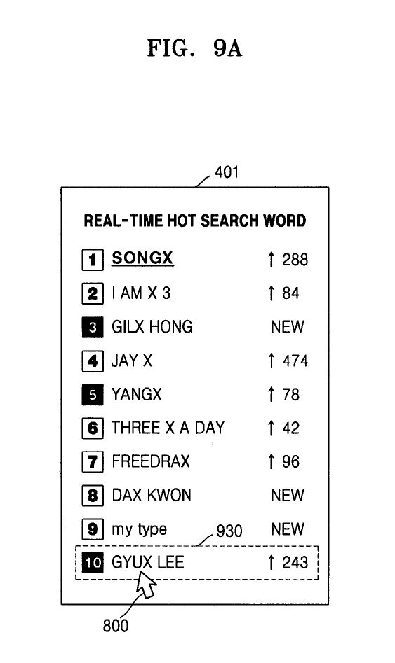

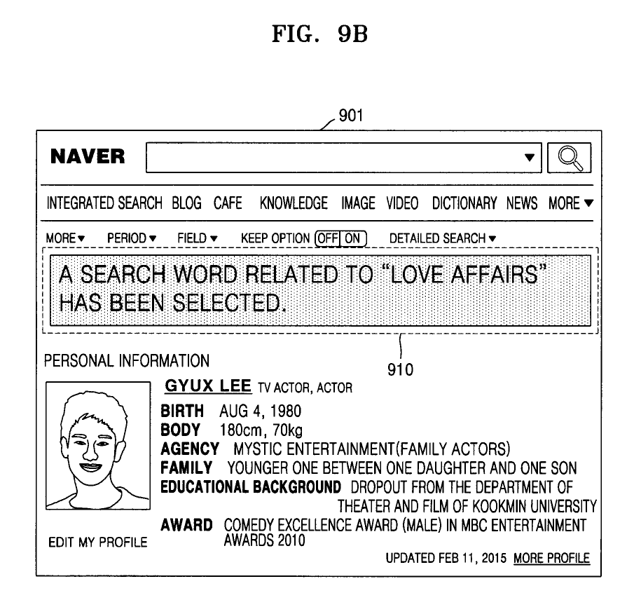

FIGS. 9A and 9B are examples of screens, in which a search word list and a search result are provided, of a user terminal 300 shown in FIG. 1.

Referring to FIGS. 9A and 9B, it is possible to see that when there is a selection input for a search word 930 in the search word list 401, the device 100 for providing a search word list shown in FIG. 1 provides a search result 901 corresponding to the selection input.

The device 100 for providing a search word list may apply a theme of a color corresponding to a tag to a search result corresponding to a search word. For example, when the tag “in love” is set in “GyuX Lee” 930 which is a search word ranking tenth in the search word list 401 and a selection signal for “GyuX Lee” 930 is input as shown in FIG. 9A, the device 100 for providing a search word list may display a pink text box 910 which corresponds to the tag “in love” and includes a sentence, such as “A search word related to “love affairs” has been selected.”, in the search result 901 corresponding to “GyuX Lee” 930. Such a method of providing a search word list according to embodiments of the present invention makes it possible to rapidly provide information wanted by a user by only one interaction, and to easily provide information frequently used by a user by inserting a keyword frequently used by the user in a template and displaying the keyword.

The above-described embodiments of the present invention may be implemented in the form of program commands that may be executed through a variety of elements of a computer and recorded in a computer-readable recording medium. The computer-readable recording medium may include program commands, data files, data structures, and the like solely or in combination. The program commands recorded in the computer-readable recording medium may be commands specially designed and constructed for the present invention or commands publicized to and used by those of ordinary skill in the computer software field. Examples of the computer-readable recording medium include magnetic media, such as a hard disk, a floppy disk, and a magnetic tape, optical recording media, such as compact disc-read only memory (CD-ROM) and a digital versatile disc (DVD), magneto-optical media, such as a floptical disk, and hardware devices specially constructed to store and execute a program command, such as a ROM, random access memory (RAM), a flash memory, and the like. Examples of the program commands include high-level language codes that can be executed by a computer using an interpreter or the like as well as machine language codes generated by a compiler. The hardware devices may be changed with one or more software modules to perform operations according to the present invention, and vice versa.

The particular implementation described in the present invention is only embodiments and do not limit the technical scope of the present invention in any ways. For conciseness of the specification, descriptions of electronic elements, control systems, software, and other functional aspects of the systems in the related art may be omitted. Also, connections of lines or connection members between elements shown in the drawings exemplify a functional connection and/or a physical or circuit connection. In an actual device, the connections or the connection members may be represented by a variety of replaceable or additional functional connections, physical connections, or circuit connections. Further, unless mentioned in detail with essential,” “important,” or the like, an element may not be an element necessarily required for application of the present invention.

Therefore, the spirit of the present invention should not be limited by the embodiments described above, and the following claims and equivalents to the claims or equivalent modifications of the claims fall within the scope of the present invention.

Embodiments of the present invention can be used in a model for providing a search word list via the Internet.

1. A method of providing a search word list to a user terminal by a processor for providing a search word list, the method comprising:
acquiring, by a tag acquisition unit of the processor, a tag set in a search word;
applying, by an effect application unit of the processor, an effect corresponding to the tag to the search word; and
providing, by a search word list providing unit of the processor, a search word list including the search word to which the effect has been applied, to the user terminal to be displayed on a screen of the user terminal.

2. The method of claim 1, wherein the applying of the effect comprises applying, by the effect application unit, a visual effect corresponding to the tag to an object corresponding to the search word.

3. The method of claim 1, wherein the applying of the effect comprises applying, by the effect application unit, a color corresponding to the tag to a ranking symbol corresponding to a rank of the search word in the search word list.

4. The method of claim 1, wherein the applying of the effect comprises applying, by the effect application unit, a color corresponding to the tag to a string of the search word.

5. The method of claim 1, wherein the applying of the effect comprises adding, by the effect application unit, an object corresponding to the tag proximate the search word according to the search word.

6. The method of claim 5, wherein the applying of the effect comprises adding, by the effect application unit, an infographic or an emoticon corresponding to the tag proximate the search word.

7. The method of claim 1, further comprising applying, by an additional effect application unit, an additional effect to the search word based on a selection signal for the search word in the search word list.

8. The method of claim 7, wherein the applying of the additional effect comprises applying, by the additional effect application unit, a visual effect corresponding to the tag to a search result provided according to the search word in the search word list when the selection signal for the search word is input.

9. The method of claim 8, wherein the visual effect is a theme of a color corresponding to the tag.

10. The method of claim 7, wherein the applying of the additional effect comprises adding, by the additional effect application unit, an object corresponding to the tag to a position adjacent to the search word in the search word list.

11. The method of claim 10, wherein the applying of the additional effect comprises inserting, by the additional effect application unit, an information message corresponding to the tag in the position adjacent to the search word when a signal for placing a pointer on the search word in the search word list is input.

12. The method of claim 1, wherein the providing of the search word list comprises providing, by the search word list providing unit, the search word list including only search words in which a tag identical to the tag set in the search word has been set when a selection signal for a ranking symbol corresponding to the search word is input.

13. The method of claim 1, wherein the providing of the search word list comprises providing, by the search word list providing unit, the search word list including only search words in which a tag identical to the tag set in the search word has been set when a selection signal for an infographic or an emoticon corresponding to the search word is input.

14. A device for providing a search word list to a user terminal, the device comprising:
a non-transitory recording medium for storing a plurality of functional units each providing instructions for performing predefined functions;
a processor in communication with the recording medium for executing the predefined functions based on the functional units, the functional units including;
a tag acquisition unit configured to acquire a tag set in a search word;
an effect application unit configured to apply an effect corresponding to the tag to the search word; and
a search word list providing unit configured to provide a search word list including the search word to which the effect has been applied, to the user terminal to be displayed on a screen of the user terminal.

15. The device of claim 14, wherein the effect application unit applies a visual effect corresponding to the tag to an object corresponding to the search word in the search word list.

16. The device of claim 14, wherein the effect application unit adds an object corresponding to the tag proximate the search word in the search word list according to the search word.

17. The device of claim 14, further comprising an additional effect application unit configured to apply an additional effect to the search word based on an input signal for the search word in the search word list.

18. A non-transitory computer readable recording medium storing a computer program for providing a search word list to a user terminal, the program causing a computer to execute the method, comprising
acquiring a tag set in a search word;
applying an effect corresponding to the tag to the search word; and
providing a search word list including the search word to which the effect has been applied, to the user terminal to be displayed on a screen of the user terminal.

19. A distribution server for distributing a program for causing a computer to execute the method of claim 1.
